(19) United States
(12) Patent Application Publication
(10) Pub. No.: US 2014/0324916 A1
(43) Pub. Date: Oct. 30, 2014

(54) METHOD AND APPARATUS FOR DATABASE

(71) Applicants: Ashok Krishnaswamy, Edison, NJ (US); Praveen Kumar Chandrasekara, Bangalore (IN); Anil B. Srikantiah, Banagalore (IN)

(72) Inventors: Ashok Krishnaswamy, Edison, NJ (US); Praveen Kumar Chandrasekara, Bangalore (IN); Anil B. Srikantiah, Banagalore (IN)

(21) Appl. No.: 13/872,482

(22) Filed: Apr. 29, 2013

(51) Int. Cl. G06F 17/30

(52) U.S. Cl. CPC G06F 17/30339
USPC 707/803

(57) ABSTRACT

A method is provided of storing in a computer memory a first plurality of database tables each of which include research data which relates to clinical or pre-clinical research studies concerning a biomedical product. The method may also include storing in the computer memory a second plurality of database tables each of which include non research data concerning the biomedical product but unrelated to clinical or pre-clinical research studies concerning the biomedical product. The method may further include linking, in the computer memory, the second plurality of database tables with the first plurality of database tables.

### FIELD OF THE INVENTION

This invention relates to improved methods and apparatus concerning databases.

### BACKGROUND OF THE INVENTION

The BRIDG (Biomedical Research Integrated Domain Group) database model is a known domain database model for storing clinical trials data in the pharmaceutical/medical device/cosmetic industries. This domain model can only be used to store clinical research data. Although, large pharmaceutical companies generate other types of data other than research data, such as manufacturing, sales and logistics data, the BRIDG domain model based database, in the past has not been capable of storing data from these domains.

In a general sense, it is known to add more columns, or data attributes or memory locations to a BRIDG domain model database table.

### SUMMARY OF THE INVENTION

One or more embodiments of the present invention extend and improve upon a BRIDG domain model based database to facilitate easier searching for data based on product, product category, product type, trial type, better system performance, and provides the ability to link data from other business functions (such as manufacturing, sales) with pharmaceutical/clinical research data. One or more embodiments, of the present invention provide custom configured database tables which are linked to biomedical research database tables, such as to BRIDG domain model based database tables. This adds utility and performance to the resulting database. In at least one embodiment, an apparatus is provided which stores and retrieves data about a product, such as a biomedical product, a pharmaceutical product, a biological product, or a medical device. The data can be about the chemistry of the product, its actions on living organisms, it's stability over a period of time, its unwarranted effects on a human body, the process of manufacturing it or about its commercial viability.

One or more embodiments of the present invention extend an existing biomedical research domain model based database model with, such as the BRIDG domain based database model, with additional database tables, which allow storage of data on other aspects of a product, such as a biomedical product, a pharmaceutical product, a biological product, or a medical device. It also allows us in categorizing product data including research data based on product type, product category and trial type.

In at least one embodiment, an apparatus is provided including a computer memory; a computer interactive device; and a computer processor linked by a communications link to the computer memory and to the computer interactive device. The computer processor may be programmed by computer software stored in the computer memory to store in the computer memory a first plurality of database tables each of which include research data which relates to clinical or pre-clinical research studies concerning a biomedical product.

The computer processor may be programmed by computer software stored in the computer memory to store in the computer memory a second plurality of database tables each of which include non research data concerning the biomedical product but unrelated to clinical or pre-clinical research studies concerning the biomedical product. The computer processor may be programmed by computer software stored in the computer memory to link, in the computer memory, the second plurality of database tables with the first plurality of database tables.

Each of the first plurality of database tables may be a biomedical research integrated domain group (BRIDG) model database table. The non research data may include data about sales of the biomedical product, cost of the biomedical product, degradation of the biomedical product over a period of time, and/or manufacturing of the biomedical product.

One or more embodiments of the present application may also provide a method which may include storing in computer memory a first plurality of database tables each of which include research data which relates to clinical or pre-clinical research studies concerning a biomedical product; storing in the computer memory a second plurality of database tables each of which include non research data concerning the biomedical product but unrelated to clinical or pre-clinical research studies concerning the biomedical product; and linking, in the computer memory, the second plurality of database tables with the first plurality of database tables.

### BRIEF DESCRIPTION OF THE DRAWINGS

FIG. 1 shows a block diagram of components of a user computer, and a server computer, communicating via the internet, for use in accordance with one or more embodiments of the present invention;

FIG. 2 shows a diagram of a plurality of database tables, each of which have been linked by one or more links to other database tables of the plurality of database tables, in accordance with one or more embodiments of the present invention;

FIG. 3 shows a diagram which identifies the possible contents of an animal type table which can be stored in the server computer memory of FIG. 1, in accordance with one or more embodiments of the present invention;

FIG. 4 shows a diagram which identifies the possible contents of a generic product table which can be stored in the server computer memory of FIG. 1, in accordance with one or more embodiments of the present invention;

FIG. 5 shows a diagram which identifies the possible contents of a trials type table which can be stored in the server computer memory of FIG. 1, in accordance with one or more embodiments of the present invention;

FIG. 6 shows a diagram which identifies the possible contents of a product type table which can be stored in the server computer memory of FIG. 1, in accordance with one or more embodiments of the present invention;

FIG. 7 shows a diagram which identifies the possible contents of a product category table which can be stored in the server computer memory of FIG. 1, in accordance with one or more embodiments of the present invention;

FIG. 8 shows a diagram which identifies the possible contents of a product toxicology information table which can be stored in the server computer memory of FIG. 1, in accordance with one or more embodiments of the present invention;

FIG. 9 shows a diagram which identifies the possible contents of a BRIDG (Biomedical Research Integrated Domain Group) domain based product table which can be stored in the server computer memory of FIG. 1, in accordance with one or more embodiments of the present invention;

FIG. 10 shows a diagram which identifies the possible contents of a BRIDG domain based animal table which can be stored in the server computer memory of FIG. 1, in accordance with one or more embodiments of the present invention;

FIG. 11 shows a diagram which identifies the possible contents of a BRIDG domain based organization table which can be stored in the server computer memory of FIG. 1, in accordance with one or more embodiments of the present invention;

FIG. 12 shows a diagram which identifies the possible contents of a BRIDG domain based defined activity table which can be stored in the server computer memory of FIG. 1, in accordance with one or more embodiments of the present invention;

FIG. 13 shows a diagram which identifies the possible contents of a BRIDG domain based planned activity table which can be stored in the server computer memory of FIG. 1, in accordance with one or more embodiments of the present invention;

FIG. 14 shows a diagram which identifies the possible contents of a BRIDG domain based performed activity table which can be stored in the server computer memory of FIG. 1, in accordance with one or more embodiments of the present invention;

FIG. 15 shows a diagram which identifies the possible contents of a BRIDG domain based adverse event table which can be stored in the server computer memory of FIG. 1, in accordance with one or more embodiments of the present invention;

FIG. 16 shows a diagram which identifies the possible contents of a BRIDG domain based study protocol table which can be stored in the server computer memory of FIG. 1, in accordance with one or more embodiments of the present invention;

FIG. 17 shows a diagram which identifies the possible contents of a BRIDG domain based scheduled activity table which can be stored in the server computer memory of FIG. 1, in accordance with one or more embodiments of the present invention; and

FIG. 18 shows a block diagram of a clinical and pre-clinical research data base linked to a product information independent of clinical, pre-clinical research database

### DETAILED DESCRIPTION OF THE DRAWINGS

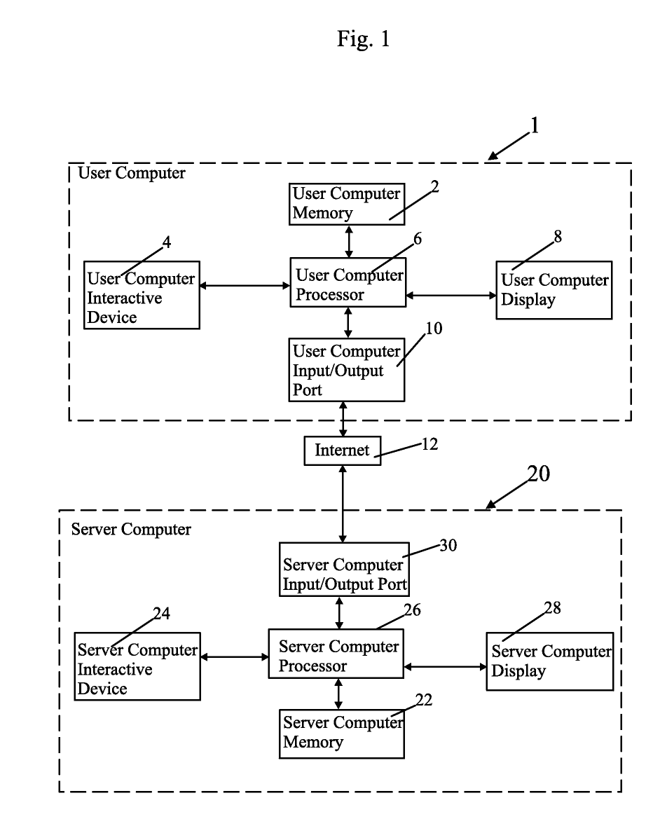

FIG. 1 shows a block diagram of components of a user computer 1, and a server computer 20, communicating via the internet 12, for use in accordance with one or more embodiments of the present invention.

The user computer 1 includes a user computer memory 2, a user computer interactive device 4, a user computer processor 6, a user computer display 8, and a user computer input/output port 10. The user computer interactive device 4 may be a computer touch screen, a computer keyboard, and/or a computer mouse, and/or any other type of computer interactive device.

The server computer 20 includes a server computer memory 22, a server computer interactive device 24, a server computer processor 26, a server computer display 28, and a server computer input/output port 30. The server computer interactive device 24 may be a computer touch screen, a computer keyboard, and/or a computer mouse, and/or any other type of computer interactive device.

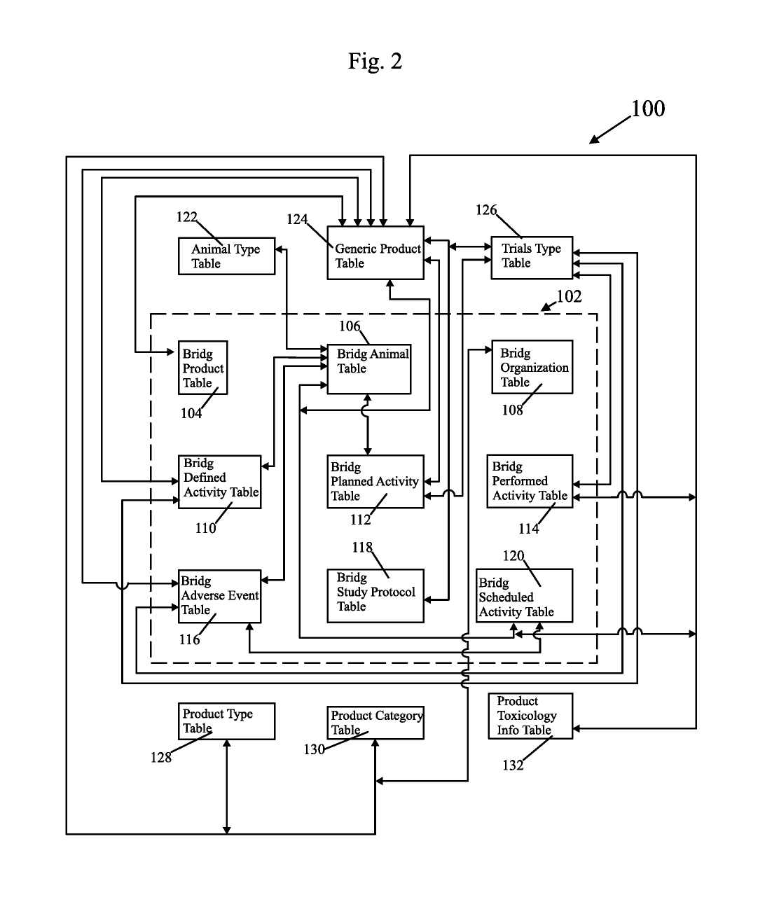

FIG. 2 shows a diagram 100 of a plurality of database tables, each of which have been linked by one or more links to other database tables of the plurality of database tables, in accordance with one or more embodiments of the present invention.

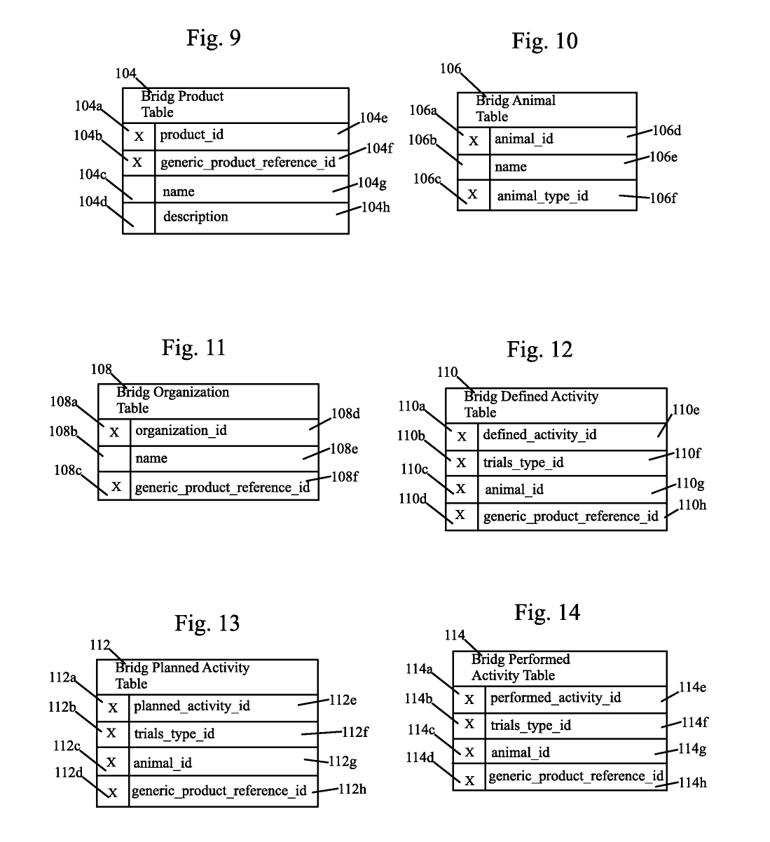

The diagram 100 includes a plurality 102 of BRIDG model (Biomedical Research Integrated Domain Group model) domain based database tables. The general concept of BRIDG domain based model data base tables is known in the art. In FIG. 2, the plurality 102 of BRIDG domain based model database tables includes BRIDG domain based product table 104, BRIDG domain based animal table 106, BRIDG domain based organization table 108, BRIDG domain based defined activity table 110, BRIDG domain based planned activity table 112, BRIDG domain based performed activity table 114, BRIDG domain based adverse event table 116, BRIDG domain based study protocol table 118, and BRIDG domain based scheduled Activity table 120. “BRIDG” domain based tables in a general sense are known in the art, however, in one or more embodiments of the present invention various data, rows, links, memory locations, columns and/or data attributes which were not previously provided in various BRIDG domain based tables have been added to BRIDG domain based tables to provide links to other tables (such as tables 122, 124, 126, 128, 130, and 132) which have been developed and/or created in accordance with one or more embodiments of the present invention. Each of BRIDG domain based tables 104, 106, 108, 110, 112, 114, 116, 118, and 120 would typically include more data rows, columns, memory locations, links, and/or data attributes than shown in FIGS. 9-17, and many of these additional data rows, columns, links, memory locations, and/or data attributes, not shown, are known in the art.

The plurality 102 of BRIDG model database tables may be stored in the server computer memory 22, and may be downloaded from the internet 12 onto the user computer 1, and into the user computer memory 2 by the user computer processor 6.

In FIG. 2, one or more of the plurality 102 of BRIDG domain based model database tables may be linked, by one or more computer software links stored in the server computer memory 22, to one or more of other BRIDG domain based model database tables of the plurality 102. In the present application “linked” shall include relating or connecting two or more database tables by a computer software link stored in computer memory, such as in the server computer memory 22. For example, in FIG. 2, the BRIDG domain based defined activity table 110 is linked to the BRIDG domain based animal table 106. The BRIDG domain based animal table 106 is also linked to the BRIDG domain based planned activity table 112, the BRIDG domain based adverse event table 116, and the BRIDG domain based scheduled activity table 120. The BRIDG domain based adverse event table 116 is also linked to the BRIDG domain based scheduled activity table 120.

FIG. 2 shows six database tables, which are not BRIDG domain based model database tables, and which have been created, configured, and constructed in accordance with one or more embodiments of the present invention. These six non BRIDG model database tables include animal type table 122, generic product table 124, trials type table 126, product type table 128, product category table 130, and product toxicology info (information) table 132. Each of the tables 122, 124, 126, 128, 130, and 132 may be stored in the server computer memory 22.

In FIG. 2, the animal type table 122 is linked to the BRIDG domain based animal table 106. The generic product table 124 is linked to all nine of the plurality 102 of BRIDG domain based model database tables, including tables 104, 106, 108, 110, 112, 114, 116, 118, and 120. The generic product table 124 is also linked to four of the other five tables which are non-BRIDG model tables, which includes tables 126, 128, 130, and 132. The only table the generic product table 124 is not linked to, directly, is the animal type table 122.

The trial type table 126 is linked to the generic product table 124, the BRIDG domain based planned activity table 112, the BRIDG domain based defined activity table 110, the BRIDG domain based adverse event table 116, and the BRIDG domain based performed activity table 120.

The product type table 128 is linked to the generic product table 124, the product category table 130, and the BRIDG domain based organization table 108. The product category table 130 is linked to the generic product table 120, the product type table 128, and the BRIDG domain based organization table 108. The product toxicology info table 132 is linked to the BRIDG domain based scheduled activity table 120, the BRIDG domain based Animal table 106, the BRIDG domain based performed activity table 114, and the generic product table 124.

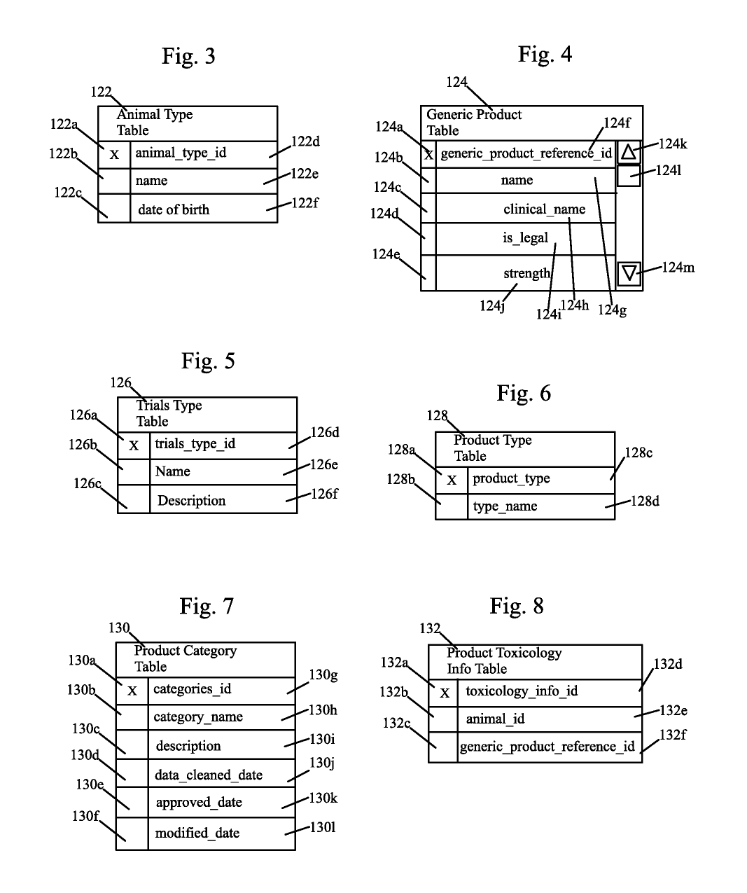

FIG. 3 shows a diagram which identifies the possible contents of an animal type table 122 which can be stored in the server computer memory 22 of FIG. 1, in accordance with one or more embodiments of the present invention. In accordance with an embodiment of the present invention, a new attribute and/or row of data “animal_type_id” 106f is added to the BRIDG domain based Animal table 106 and this links to the custom created animal type table 122. This is done to help categorize the animals that are used for different trial phases.

The animal type table 122 includes or has associated therewith a plurality of rows and columns of data stored in memory locations or cells of the server computer memory 22. In a first row, first column or memory cell or memory location 122a, an indication is stored that the data in memory location 122d will be used as a computer software link to another table. In the first row, second column or memory cell or location 122d, data for the variable “animal_type_id” is stored. The “X” in cell 122a indicates that the “animal_type_id” is used as a computer software link to another table. In this example, the “animal_type_id” data is used to link the animal type table 122 with the BRIDG domain based animal table 106 as shown by FIGS. 2, 3, and 10.

The animal type table 122 also has associated with it, memory locations 122b, 122c, 122e, and 122f. The memory location 122e includes data regarding the name of an animal; and the memory location 122f includes data regarding the date of birth of the particular animal referred to by the data in location 122d and 122e. The locations 122b and 122c are blank to indicate that the data for 122e and 122f are not used as links to another database table in this example.

FIG. 4 shows a diagram which identifies the possible contents of a generic product table 124 which can be stored in the server computer memory 22 of FIG. 1, in accordance with one or more embodiments of the present invention. The generic product table 124, in at least one embodiment, is used to store data about all products which a company manufactures, sells or obsolete products. The generic product table 124, in at least one embodiment maintains data for commercial name, scientific name, status (approved sell/unapproved), potency, formulation, method of ingestion (i.e. device, stem Cell, cosmetic) and other administrative information about a product. The generic product table 124 may be linked to the product category table 130 shown in FIG. 7.

In at least one embodiment of the present invention, the data row or attribute generic_product_reference_id” is added and/or introduced into the BRIDG domain based tables 108, 110, 112, 114, 116, 118,104 and 120. This data row or attribute was not previously provided in BRIDG domain based tables. The “generic_product_reference_id” data is used as a link to the custom created generic product table 124.

In at least one embodiment of the present invention, the data row or attribute “trials_type_id” is added and/or introduced into the BRIDG domain based tables 110, 112, 114, 116, 118, and 120. This data row or attribute was not previously provided in BRIDG domain based tables. The “trials_type_id” data is used as a link to the custom created trials type table 126.

In at least one embodiment of the present invention, the data row or attribute “animal_id” is added and/or introduced into the BRIDG domain based tables 110, 112, 114, 116, 118, and 120. This data row or attribute was not previously provided in the specific BRIDG domain based tables referred to. The “animal_id” data is used as a link to the custom created animal type table 122. In at least one embodiment, this optimizes a search path for a user, such as a user of user computer 1.

The generic product table 124 includes or has associated therewith a plurality of rows and columns of data stored in memory locations or cells of the server computer memory 22. In a first row, first column or memory cell or memory location 124a, an indication is stored that the data in memory location 124f will be used as a computer software link to another table. In the first row, second column or memory cell or location 124f, data for the variable “product_id” is stored. The “X” in cell 124a indicates that the “product_id” is used as a computer software link to another table. In this example, the “product_id” data is used to link the generic product table 124 with tables 104, 106, 108, 110, 112, 114, 116, 118, 120, 126, 128, 130, and 132; which is all of the other tables in FIG. 2 except for the animal type table 122.

The generic product table 124 also has associated with it, memory locations 124b, 124c, 124d, 124e, 124f, 124g, 124h, 124i, and 124j. The generic product table 124 is configured to be displayed on a computer display, such as user computer display 8 or server computer display 28 by the computer processor 6 and 26, respectively, of FIG. 1, in response to computer software stored in computer memory 2 and 22, respectively, such that scroll arrows 124k and 124m and scroll bar 124l are displayed on computer display 8 and/or 28. The scroll arrows 124k and 124m and the scroll bar 124l can be used to scroll down and/or select the data of 124f-j (properties of a pharmaceutical product) to display product category linkage to a particular product as well as product type linkage for the product. In one or more embodiments, there may also be data attributes, memory locations, or rows like comparator product id not shown in FIG. 4, that are associated with generic_product table 124 that would be displayed. The memory location 124g has data for the name of a product. The memory location 124h has a clinical name of a product. The memory location 124i has an indication of whether the product referred to by 124g and 124h is legal. Data indicating the strength of the product referred to by 124g, is stored in memory location 124j.

FIG. 5 shows a diagram which identifies the possible contents of a trials type table 126 which can be stored in the server computer memory 22 of FIG. 1, in accordance with one or more embodiments of the present invention. In at least one embodiment, the trials type table 126 is used to store the type of trial and link it to the BRIDG domain based defined activity table 110. This link improves the usability of the overall database comprised of all of the tables and links shown in FIG. 2.

The trials type table 126 includes or has associated therewith a plurality of rows and columns of data stored in memory locations or cells of the server computer memory 22. In a first row, first column or memory cell or memory location 126a, an indication is stored that the data in memory location 126d will be used as a computer software link to another table. In the first row, second column or memory cell or location 126d, data for the variable “trials_type_id” is stored. The “X” in cell 126a indicates that the “trials_type_id” data is used as a computer software link to another table. In this example, the “trials_type_id” data is used to link the trials type table 126 with tables 124, 118, 114, 116, 110, 130, and 128.

The trial type table 126 also has associated with it, memory locations 126b, 126c, 126d, 126e, and 126f. The memory location 126d has data for a “trials_type_id” which is an indication of a specific trial or series of trials for a product, such as a drug trial or trials. The memory location 126e has a name of a trial stored therein. The memory location 126f has a data for a description of trial referred to in location 126e, stored therein.

FIG. 6 shows a diagram which identifies the possible contents of a product type table 128 which can be stored in the server computer memory 22 of FIG. 1, in accordance with one or more embodiments of the present invention. In at least one embodiment the product type table 128 is a custom created table introduced to achieve categorization of a product based on usage such as whether the product is a medical device, a stem cell therapy or a formulation, a cosmetic, a food additive etc. The product type table 128 may have data or attributes such as product_type_id, name, and description.

The product type table 128 includes or has associated therewith a plurality of rows and columns of data stored in memory locations or cells of the server computer memory 22. In a first row, first column or memory cell or memory location 128a, an indication is stored that the data in memory location 128c will be used as a computer software link to another table. In the first row, second column or memory cell or location 128c, data for the variable “product_type” is stored. The “X” in cell 128a indicates that the “product_type” data is used as a computer software link to another table. In this example, the “product_type” data is used to link the product type table 128 with tables 124, 130, and 108.

The product type table 128 also has associated with it, memory locations 128b and 128d. The memory location 128d has data for a “type_name” which is data for a name of a specific type of product. The memory location 128b is blank indicating that the data in memory location 128d is not used as a link in this example.

FIG. 7 shows a diagram which identifies the possible contents of a product category table 130 which can be stored in the server computer memory 22 of FIG. 1, in accordance with one or more embodiments of the present invention.

In at least one embodiment, the product category table 130 stores product categorization information such as investigational, marketed, and seasonal information.

The product category table 130 includes or has associated therewith a plurality of rows and columns of data stored in memory locations or cells of the server computer memory 22. In a first row, first column or memory cell or memory location 130a, an indication is stored that the data in memory location 130g for “categories_id” will be used as a computer software link to another table. In the first row, second column or memory cell or location 130g, data for the variable “categories_id” is stored, which may be a list of pharmaceutical product categories categories of products such as for example vaccine. The “X” in cell 130a indicates that the “categories_id” data in 130g is used as a computer software link to another table. In this example, shown by the combination of FIG. 2 and FIG. 7, the “categories id” data is used to link the product category table 130 with tables 124, 128, and 108.

The product category table 130 also has associated with it, memory locations 130b, 130c, 130d, 130e, 130f, 130g, 130h, 130i, 130j, 130k, and 130l. The memory location 130h has data for a “category_name” which is data for a name of a specific category of product, such as for example biological. The memory location 130b is blank indicating that the data in memory location 130h is not used as a link in this example. The memory location 130i has data for a “description” which is data for a description of a specific category of product, such as for example created by biologic processes. The memory location 130c is blank indicating that the data in memory location 130i is not used as a link in this example. The memory location 130j has data for a “data_cleaned_date” which is data for a date of when data in the product category table 130 was last time when data was corrected (ensured that data is correct). The memory location 130d is blank indicating that the data in memory location 130j is not used as a link in this example. The memory location 130k has data for an “approved_date” which is data for a date of approval when the product category was approved by a computer user privileged to approve the data, such as through use of the user computer interactive device 4 of the user computer 1, meaning the data has been verified and found correct. The memory location 130e is blank indicating that the data in memory location 130k is not used as a link in this example. The memory location 130l has data for a “modified_date” which is data for a date of a last update to the data when the product category table 130 was last modified, such as by a user of the user computer 1, through the user computer interactive device 4. The memory location 130f is blank indicating that the data in memory location 130l is not used as a link in this example.

FIG. 8 shows a diagram which identifies the possible contents of a product toxicology information table 132 which can be stored in the server computer memory 22 of FIG. 1, in accordance with one or more embodiments of the present invention.

The product toxicology table 132 includes or has associated therewith a plurality of rows and columns of data stored in memory locations or cells of the server computer memory 22. In a first row, first column or memory cell or memory location 132a, an indication is stored that the data in memory location 132d for “toxicology_info_id” will be used as a computer software link to another table. In the first row, second column or memory cell or location 132d, data for the variable “toxicology_info_id” is stored, which may be an identification of toxicology, for example a unique identifier for toxicology test. The “X” in cell 132a indicates that the “toxicology_info_id” data in 132d is used as a computer software link to another table. In this example, shown by the combination of FIG. 2 and FIG. 8, the “toxicology_info_id” data is used to link the product toxicology table 132 with tables 124, 106, 120, and 114.

The product toxicology information table 130 also has associated with it, memory locations 132b, 132c, 132d, 132e, and 132f. The memory location 132e has data for “animal_id” which is data for an identification of an animal such as, a guinea pig, for example. The memory location 132b is blank indicating that the data in memory location 132e is not used as a link in this example. The memory location 132f has data for a “product_id” which is data for an identification of a product such as for example, acetyl salicylic acid. The memory location 132c is blank indicating that the data in memory location 132f is not used as a link in this example.

FIG. 9 shows a diagram which identifies the possible contents of a BRIDG (Biomedical Research Integrated Domain Group) domain based product table 104 which can be stored in the server computer memory 22 of FIG. 1, in accordance with one or more embodiments of the present invention.

The BRIDG domain based product table 104 includes or has associated therewith a plurality of rows and columns of data stored in memory locations or cells of the server computer memory 22. In a first row, first column or memory cell or memory location 104a, an indication is stored that the data in memory location 104e for “product_id” will be used as a computer software link to another table. In the first row, second column or memory cell or location 104e, data for the variable “product_id” is stored, which may be an indentification of a product, for example, a unique id or identification for a product. The “X” in cell 104a indicates that the “product_id” data in 104e is used as a computer software link to another table. In this example, shown by the combination of FIG. 2 and FIG. 9, the “product_id” data is used to link the BRIDG domain based product table 104 with table 124.

The BRIDG domain based product table 104 also has associated with it, memory locations 104b, 104c, 104d, 104f, 104g, and 104h. The memory location 104f has data for “generic_product_reference_id” which is data for an identification of a general product such as acetyl salicylic acid. The memory location 104b has an “X” representing an indicator store in memory 22, indicating that the data in memory location 104f is used as a link, in this example, to the generic product table 124. The memory location 104g has data for a “name” which is data for name of a product such as for example acetyl salicylic acid. The memory location 104c is blank indicating that the data in memory location 104g is not used as a link in this example. The memory location 104h has data for a “description” which is data for description of a product such as, for example, a pain killer. The memory location 104d is blank indicating that the data in memory location 104h is not used as a link in this example.

FIG. 10 shows a diagram which identifies the possible contents of a BRIDG domain based animal table 106 which can be stored in the server computer memory 22 of FIG. 1, in accordance with one or more embodiments of the present invention.

The BRIDG domain based animal table 106 includes or has associated therewith a plurality of rows and columns of data stored in memory locations or cells of the server computer memory 22. In a first row, first column or memory cell or memory location 106a, an indication is stored that the data in memory location 106d for “animal_id” will be used as a computer software link to another table. In the first row, second column or memory cell or location 106d, data for the variable “animal_id” is stored, which may be an identification of an animal. The “X” in cell 106a indicates that the “animal_id” data in 106d is used as a computer software link to another table. In this example, shown by the combination of FIG. 2 and FIG. 10, the “animal_id” data is used to link the BRIDG domain based animal table 106 with tables 122, 110, 116, 120, 112, 132, 114, and 124.

The BRIDG domain based animal table 106 also has associated with it, memory locations 106b, 106c, 106e, and 106f. The memory location 106e has data for “name” which is data for an identification of a name of an animal such as a guinea pig for example. The memory location 106b is blank indicating that the data in memory location 106e is not used as a link in this example. The memory location 106f has data for “animal_type_id” which is data for an identification of a type of animal such as for example an infected animal with a certain health condition. The memory location 106c shows an “X” to indicate that the data in memory location 106f is used as a link in this example, such as for example, linking the BRIDG domain based animal table 106 in FIG. 10 with the animal type table 122 shown in FIG. 3.

FIG. 11 shows a diagram which identifies the possible contents of a BRIDG domain based organization table 108 which can be stored in the server computer memory 22 of FIG. 1, in accordance with one or more embodiments of the present invention. In at least one embodiment of the present invention the data attribute or data row for “generic_product_reference_id” 108f has been added which links to the custom generic product table 124 and which simplifies searching the overall database of FIG. 2.

The BRIDG domain based organization table 108 includes or has associated therewith a plurality of rows and columns of data stored in memory locations or cells of the server computer memory 22. In a first row, first column or memory cell or memory location 108a, an indication is stored that the data in memory location 108d for “organization_id” will be used as a computer software link to another table. In the first row, second column or memory cell or location 108d, data for the variable “organization_id” is stored, which may be an identification of an organization, for example a unique id for the organization. The “X” in cell 108a indicates that the “organization_id” data in 108d is used as a computer software link to another table. In this example, shown by the combination of FIG. 2 and FIG. 11, the “orgainzation_id” data is used to link the BRIDG domain based organization table 108 with tables 130, 124, and 128.

The BRIDG domain based organization table 108 also has associated with it, memory locations 108b, 108c, 108e, and 108f. The memory location 108e has data for “name” which is data for a name of an organization such as a name of a hospital, for example. The memory location 108b is blank indicating that the data in memory location 108e is not used as a link in this example. The memory location 108f has data for “generic_product_reference_id” which is data for an identification number for a generic product such as for example, acetyl salicylic acid. The memory location 108c shows an “X” indicating that the data in memory location 108f is not used as a link in this example, to the custom created generic product table 124 shown in FIG. 4.

FIG. 12 shows a diagram which identifies the possible contents of a BRIDG domain based defined activity table 110 which can be stored in the server computer memory 22 of FIG. 1, in accordance with one or more embodiments of the present invention. In at least one embodiment, three data attributes and/or rows have been introduced and/or added to the BRIDG domain based defined activity table 110. The added data attributes and/or rows are “generic_product_reference_id” 110h that links to the custom generic product table 124, “trials_type_id” 110f that links to the custom trials type table 126 and “animal_id” 110g that links to BRIDG domain based animal table 106.

The BRIDG domain based defined activity table 110 includes or has associated therewith a plurality of rows and columns of data stored in memory locations or cells of the server computer memory 22. In a first row, first column or memory cell or memory location 110a, an indication is stored that the data in memory location 110e for “defined_activity_id” will be used as a computer software link to another table. In the first row, second column or memory cell or location 110e, data for the variable “defined_activity_id” is stored, which may be an identification of a defined activity such as a test procedure, for example acollection of a blood sample. The “X” in cell 110a indicates that the “defined_activity_id” data in 110e is used as a computer software link to another table. In this example, shown by the combination of FIG. 2 and FIG. 12, the “defined_activity_id” data of 110e is used to link the BRIDG domain based defined activity table 110 with tables 106, 124. and 126.

The BRIDG domain based defined activity table 110 also has associated with it, memory locations 110b, 110c, 110d, 110f, 110g, and 110h. The memory location 110f has data for “trials_type_id” which is data for an identification of a trial or a series of trials, such as drug trials such as a phase two clinical trials, for example a study for comparing a new drug therapy with an existing drug therapy. The memory location 110b shows an “X”, corresponding to an indicator in memory 22, indicating that the data in memory location 110f is used as a link in this example, to the custom trials type table 126 shown in FIG. 5. The memory location 110g has data for “animal_id” which is data for an identification number for an animal such as for example an identification number on an lab animal. The memory location 110c has an “X” corresponding to a stored indicator in memory 22, indicating that the data in memory location 110g is used as a link in this example, to the BRIDG domain based animal table 106. The memory location 110h has data for “generic_product_reference_id” which is data for an identification for a generic product, such as for example acetyl salicylic acid. The memory location 110d shows an “X” representing a stored indicator in memory 22, indicating that the data in memory location 110h is used as a link, in this example to custom created generic product table 124 of FIG. 4.

FIG. 13 shows a diagram which identifies the possible contents of a BRIDG domain based planned activity table 112 which can be stored in the server computer memory 22 of FIG. 1, in accordance with one or more embodiments of the present invention. In at least one embodiment, three data attributes and/or rows have been introduced and/or added to the BRIDG domain based planned activity table 112. The added data attributes and/or rows are “generic_product_reference_id” 112h that links to the custom generic product table 124, “trials_type_id” 112f that links to the custom trials type table 126 and “animal_id” 112g that links to BRIDG domain based animal table 106.

The BRIDG domain based planned activity table 112 includes or has associated therewith a plurality of rows and columns of data stored in memory locations or cells of the server computer memory 22. In a first row, first column or memory cell or memory location 112a, an indication is stored that the data in memory location 112e for “planned_activity_id” will be used as a computer software link to another table. In the first row, second column or memory cell or location 112e, data for the variable “planned_activity_id” is stored, which may be an identification of a planned activity such as a lab test, for example a blood glucose level. The “X” in cell 112a indicates that the “planned_activity_id” data in 112e is used as a computer software link to another table. In this example, shown by the combination of FIG. 2 and FIG. 13, the “planned_activity_id” data of 112e is used to link the BRIDG domain based planned activity table 112 with tables 124, 126, and 106.

The BRIDG domain based planned activity table 112 also has associated with it, memory locations 112b, 112c, 112d, 112f, 112g, and 112h. The memory location 112f has data for “trials_type_id” which is data for an identification of a trial or a series of trials, such as drug trials such as clinical trials for example a phase two clinical trial. The memory location 112b shows an “X” representing an indicator stored in memory 22, indicating that the data in memory location 112f is used as a link, in this example, to the trials type table 126. The memory location 112g has data for “animal_id” which is data for an identification number for an animal such as for example an identification number on a lab animal. The memory location 112c shows an “X” representing a stored indicator in memory 22 indicating that the data in memory location 112g is used as a link, in this example to the BRIDG domain based animal table 106. The memory location 112h has data for “generic_product_reference_id” which is data for an identification for a generic product, such as for example acetyl salicylic acid. The memory location 112d shows an “X” representing a stored indictor in memory 22, indicating that the data in memory location 112h is used as a link, in this example, to the custom created generic product table 124.

FIG. 14 shows a diagram which identifies the possible contents of a BRIDG domain based performed activity table 114 which can be stored in the server computer memory 22 of FIG. 1, in accordance with one or more embodiments of the present invention. In at least one embodiment, three data attributes or data rows have been created and/or added to the table 114. The data attributes and/or data rows are “generic_product_reference_id” 114h that links to the generic product table 124, “trials_type_id” 114f that links to the trials type table 126 and “animal_id” 114g that links to the BRIDG domain based Animal table 106.

The BRIDG domain based performed activity table 114 includes or has associated therewith a plurality of rows and columns of data stored in memory locations or cells of the server computer memory 22. In a first row, first column or memory cell or memory location 114a, an indication is stored that the data in memory location 114e for “performed_activity_id” will be used as a computer software link to another table. In the first row, second column or memory cell or location 114e, data for the variable “performed_activity_id” is stored, which may be an identification of a performed activity such as a lab test, for example a blood glucose level test. The “X” in cell 114a indicates that the “performed_activity_id” data in 114e is used as a computer software link to another table. In this example, shown by the combination of FIG. 2 and FIG. 14, the “performed_activity_id” data of 114e is used to link the BRIDG domain based performed activity table 114 with tables 124, 126, 106, 132, and 106.

The BRIDG domain based performed activity table 114 also has associated with it, memory locations 114b, 114c, 114d, 114f, 114g, and 114h. The memory location 114f has data for “trials_type_id” which is data for an identification of a trial or a series of trials, such as drug trials such as clinical trials, for example phase two clinical trials. The memory location 114b has an “X” representing an indicator in memory 22, indicating that the data in memory location 114f is used as a link, in this example to trial type table 126. The memory location 114g has data for “animal_id” which is data for an identification number for an animal such as for example lab animal. The memory location 114c has an “X” representing an indicator in memory 22, indicating that the data in memory location 112g is used as a link, in this example to the BRIDG domain based animal table 106. The memory location 114h has data for “generic_product_reference_id” which is data for an identification for a generic product, such as for example acetyl salicylic acid. The memory location 114d has an “X” representing an indicator, indicating that the data in memory location 114h is used as a link, in this example to the custom created generic product table 124.

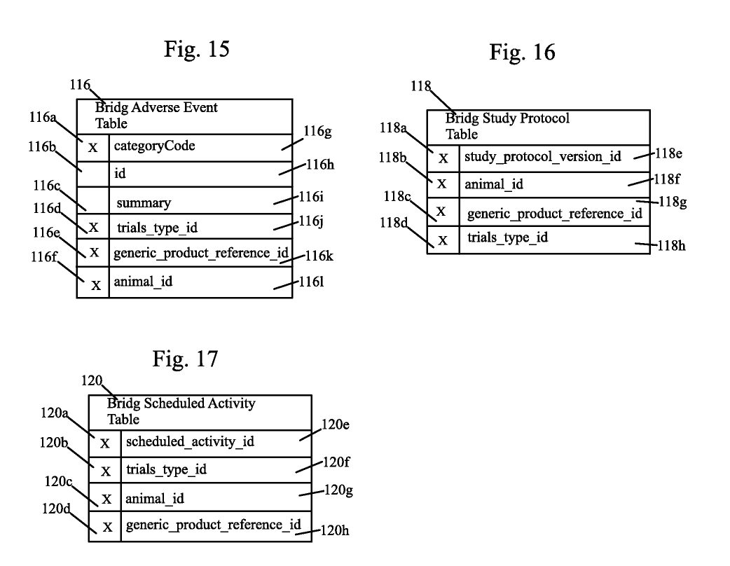

FIG. 15 shows a diagram which identifies the possible contents of a BRIDG domain based adverse event table 116 which can be stored in the server computer memory 22 of FIG. 1, in accordance with one or more embodiments of the present invention. It at least one embodiment of the present invention three data attributes and/or data rows are created and added to the BRIDG domain based Adverse Event table 116. The data attributes or data rows are “generic_product_reference_id” 116k that links to the generic product table 124, “trials_type_id” 116j that refers to the custom trials type table 126 and :animal_id” 116l that links to the BRIDG domain based animal table 106.

The BRIDG domain based adverse event table 116 includes or has associated therewith a plurality of rows and columns of data stored in memory locations or cells of the server computer memory 22. In a first row, first column or memory cell or memory location 116a, an indication is stored that the data in memory location 116g for “categoryCode” will be used as a computer software link to another table. In the first row, second column or memory cell or location 116g, data for the variable “categoryCode” is stored, which may be an identification of a category code such as category, for example clinical case. The “X” in cell 116a indicates that the category code data in 116g is used as a computer software link to another table. In this example, shown by the combination of FIG. 2 and FIG. 15, the “categoryCode” data of 116g is used to link the BRIDG domain based Adverse Event table 116 with tables 124, 126, 120, and 106.

The BRIDG domain based adverse event table 116 also has associated with it, memory locations 116b, 116c, 116d, 116e, 116f, 116g, 116i, 116j, 116k, and 116l. The memory location 116h has data for “id” which is data for an identification number of an adverse event, such as unique identifier for an adverse event report. The memory location 116b is blank indicating that the data in memory location 116h is not used as a link in this example. The memory location 116i has data for “summary” which is data for the summary of what the adverse event is. The memory location 116c is blank indicating that the data in memory location 116i is not used as a link in this example. The memory location 116j has data for “trials_type_id” which is data for an identification of a trials type during which the adverse event occurred a generic product, such as for example phase three clinical trial. The memory location 116d has an “X” representing an indicator, indicating that the data in memory location 116j is used as a link, in this example to the trials type table 126. The memory location 116k has data for “generic_product_reference_id” which is data for an identification of a generic product that refers to this adverse event, such as for example acetyl salicylic acid. The memory location 116e has an “X” representing an indicator in memory 22, indicating that the data in memory location 116k is used as a link, in this example to the generic product table 124. The memory location 116l has data for “animal_id” which is data for an identification of an animal, such as for example lab animal id. The memory location 116f has an “X” representing an indicator in memory 22, indicating that the data in memory location 116l is used as a link, in this example, to the BRIDG domain based animal table 106.

FIG. 16 shows a diagram which identifies the possible contents of a BRIDG domain based study protocol table 118 which can be stored in the server computer memory 22 of FIG. 1, in accordance with one or more embodiments of the present invention. In at least one embodiment, three data attributes and/or rows have been introduced and/or added to the BRIDG domain based study protocol table 118. The added data attributes and/or rows are “generic_product_reference_id” 118g that links to the custom generic product table 124, “trials_type_id” 118h that links to the custom trials type table 126 and “animal_id” 118f that links to BRIDG domain based animal table 106.

The BRIDG domain based study protocol table 118 includes or has associated therewith a plurality of rows and columns of data stored in memory locations or cells of the server computer memory 22. In a first row, first column or memory cell or memory location 118a, an indication is stored that the data in memory location 118e for “study_protocol_version_id” will be used as a computer software link to another table. In the first row, second column or memory cell or location 118e, data for the variable “study_protocol_version_id” is stored, which may be an identification of a study protocol version, for example initial version of phase three clinical trial. The “X” in cell 118a indicates that the “study_protocol_version_id” data in 118e is used as a computer software link to another table. In this example, shown by the combination of FIG. 2 and FIG. 16, the “study_protocol_version_id” data of 118e is used to link the BRIDG domain based study protocol table 118 with table 124.

The BRIDG domain based study protocol table 114 also has associated with it, memory locations 118b, 118c, 118d, 118f, 118g, and 118h. The memory location 118f has data for “animal_id” which is data for an identification of an animal such as id number for lab animal for The memory location 118b has an “X” which represents an indicator stored in memory 22, indicating that the data in memory location 118f is used as a link, in this example to the BRIDG domain based animal table 106. The memory location 118g has data for “generic_product_id” which is data for an identification number, or alphanumeric, for a generic product such as for example acetyl salicylic acid. The memory location 118c has an “X” representing an indicator in memory 22, indicating that the data in memory location 118g is used as a link, in this example, to the generic product table 124. The memory location 118h has data for “trial_type_id” which is data for an identification of a trial type, such as for example a clinical trial. The memory location 118d has an “X” representing an indicator in memory 22, indicating that the data in memory location 114h is used as a link, in this example to trials type table 126.

FIG. 17 shows a diagram which identifies the possible contents of a BRIDG domain based scheduled activity table 120 which can be stored in the server computer memory 222 of FIG. 1, in accordance with one or more embodiments of the present invention. In at least one embodiment, three data attributes and/or rows have been introduced and/or added to the BRIDG domain based scheduled activity table 120. The added data attributes and/or rows are “generic_product_reference_id” 120h that links to the custom generic product table 124, “trials_type_id” 120f that links to the custom trials type table 126 and “animal_id” 120g that links to BRIDG domain based animal table 106.

The BRIDG domain based scheduled activity table 120 includes or has associated therewith a plurality of rows and columns of data stored in memory locations or cells of the server computer memory 22. In a first row, first column or memory cell or memory location 120a, an indication is stored that the data in memory location 120e for “scheduled_activity_id” will be used as a computer software link to another table. In the first row, second column or memory cell or location 120e, data for the variable “scheduled_activity_id” is stored, which may be an identification of a scheduled activity such as lab test, for example blood sugar level. The “X” in cell 120a indicates that the “scheduled_activity_id” data in 120e is used as a computer software link to another table. In this example, shown by the combination of FIG. 2 and FIG. 17, the “scheduled_activity_id” data of 120e is used to link the BRIDG domain based scheduled activity table 120 with tables 106, 132, 114, and 124.

The BRIDG domain based scheduled activity table 120 also has associated with it, memory locations 120b, 120c, 120d, 120f, 120g, and 120h. The memory location 120f has data for “trials_type_id” which is data for an identification of a trials type, such as clinical trials, for example phase three clinical trials. The memory location 120b has an “X” representing an indicator stored in memory 22, indicating that the data in memory location 120f is used as a link, in this example to the trials type table 126. The memory location 120g has data for “animal_id” which is data for an identification number, or alphanumeric, for an animal. The memory location 120c has an “X” representing an indicator stored in memory 22, indicating that the data in memory location 120g is used as a link, in this example to the BRIDG domain based animal table 106. The memory location 120h has data for “generic_product_reference_id” which is data for a generic product reference identification. The memory location 120d has an “X” representing an indicator stored in memory 22, indicating that the data in memory location 120h is used as a link, in this example, the custom created generic product table 124.

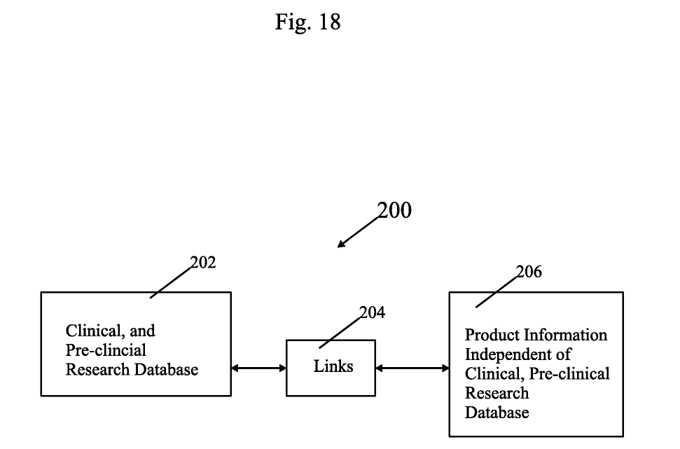

FIG. 18 shows a block diagram 200 of a clinical and pre-clinical research database 202 linked by a link 204 to a product information independent of clinical, pre-clinical research database 206. The link 204 may actually include a plurality of links. In at least one embodiment, the link or links 204 may be data stored in computer memory such as computer memory 2 or 22 of FIG. 1 which links clinical, and/or pre-clinical research data in database 202 of a biomedical product with information independent of the clinical, and/or pre-clinical research data in database 206. For example, the row, data or attribute for “generic_product_reference_id” as shown for 104f, 108f, 110h, 116k, 120h, and 118g, which have been added to Bridg tables, as shown by FIGS. 9-17 may be stored in computer memory 2 or 22 of FIG. 1 and may be used as links for link or links 204 to link clinical and/or pre-clinical research database 202 to database 206.

In addition, the generic product table 124 which has been created and/or configured in accordance with an embodiment of the present invention, may be stored in computer memory 2 and/or 22, and has a row, data or attribute 124f for “generic product_reference_id” 124f which can be a link of links 204, which can be linked to non-research data (not clinical or pre clinical research) database 206. The product toxicoloy information table 132 has row, data or attribute 132f for “generic_product_reference_id” which can also be a link of links 204 which link database 202 with database 206.

Note that it is also possible that an “alias”, i.e. another name, may be used to identify the “generic_product_reference_id” in another table. Generally, the use of “aliases” is known in the art.

The tables 122, 126, 128, and 130, shown in FIGS. 3, 5, 6, and 7, respectively, are used as lookup tables, and may be stored in computer memory 2 and/or 22, in accordance with at least one embodiment of the present invention. The tables 122, 126, 128, and 130, in at least one embodiment, do not have a row, data or attribute for “generic_product_reference_id” and do not link directly to non research database 206.

In accordance with an embodiment of the present invention, the generic product table 124 is a main table and is a main host for the data, row, and/or attribute “generic_product_reference_id” which is used as a link of links 204 from database 202 to database 206. The “generic_product_reference_id” data, row, and/or attribute is used a a primary key, in at least one embodiment.

The database 206 is not shown in detail, but generally may include product commercial data for a biomedical product, said commercial data may include data about sales volume, costs, profit from sales and tax figures relating to the biomedical product which generally doesn't include rclinical and/or pre-clinical research data. The database 206 may also include product stability data which may be defined as data on degradation of biomedical product over a period of time, and product manufacturing data for the biomedical product which may be defined as data on product manufacturing process including raw materials, data on raw material suppliers, and manufacturing volumes.

In FIG. 18, the links 204 may include a combination of “generic_product_reference_id”, “animal_id” and “trials_type_id” which may help categorization of research data of database 202 based on different trial type for a particular biomdecial product and may be used to link database 202 and database 206. The plurality of links 204 assist in categorization of data based on biomedical product and then based on animal/trial s type. In at least one embodiment, “generic_product_reference_id”, “trials_type_id” and “animal_id” links, such as links 110h, 110f, and 110g shown in FIG. 12, are used in conjunction to allow faster and better visualization of data when data is being searched on the basis of generic product identification, animal identification or trials type identification. This categorization of data helps when users use a search method, apparatus, and/or system in accordance with an embodiment of the present invention for different types of reports like business intelligence reports, which may be part of non research data stored in database 206 and/or in table 124 in database 206.

The Database 206 may includes product category table 130 shown in FIG. 7, product type table 128 shown in FIG. 6, product strength information and/or table not shown, product toxicology information table 132 shown in FIG. 8, and trials type table 126 shown in FIG. 5, and/or further data and/or further tables. Each of the tables in FIGS. 3-8 may include further data and/or information not shown about a biomedical product.

The link 204 in FIG. 18 between the clinical and pre-clinical research database 202 and the product information independent of clinical, pre-clinical research database 206 may be comprised of a plurality of links 204 from one or more Bridg tables of FIGS. 9-17 to data of database 206.

For example, the link or plurality of links 204 may include the link 108f “generic_product_reference_id” of Bridg table 108 of FIG. 11. The link 108f which has been added to a known Bridg table to form table 108, in accordance with an embodiment of the present invention may link the table 108 with the database 206. More specifically, the table 108 may be linked by the link 108f to the generic product table 124 of FIG. 4, which may be part of the database 206. The generic product table 124, is configured in accordance with an embodiment of the present invention to product data independent of clinical or pre-clinical research, such as name of biomedical product data 124g, clinical_name data 124h, “is_legal” data (for legal status of biomedical product in one or more countries) 124i, and strength of biomedical product data 124j.

The “generic_product_reference_id” link 108f of FIG. 11, in at least one embodiment is used with respect to categorization of an organization that has been involved in trials for a particular biomedical product. In accordance with one embodiment of the present invention, the “generic_product_reference_id” link 108f as used for categorization in FIG. 11, helps users of a computer software program stored in computer memory 2 an/or 22 in searching for an organization when a user provides a “generic_product_reference_id” into user computer interactive device 4, as an input. The user computer processor 6 and/or server computer processor 26 is programmed by computer software in computer memory 2 and/or 22 to receive a user input “generic_product_reference_Id”, compare the input “generic_product_reference_id” with a plurality of stored “generic_product_reference_id”s. and look up information on generic product table 124 such as 124g, 124h, 124i, and 124j for the input “generic_product reference_id” through link 108f.

The link or plurality of links 204 may include links 118f, 118g, 118h shown in FIG. 16, which link the BRIDG Domain based Study Protocol table 118 of FIG. 16 and the generic product table 124 (through links 118g and 124f); the BRIDG domain based Study Protocol table 118 to the trials type table 126 (through links 126d and 118h); and the BRIDG domain study protocol table 118 to the BRIDG domain animal table 106 of FIG. 10 (through links 106d and 118f). These links 118f, 118g, and 118h assist in categorization of BRIDG domain based study protocol version data of table in FIG. 16 (additional data of FIG. 16 not shown), for different trial types. For example there would be a StudyProtocolVersion for an animal say “Rat” and another StudyProtocolVersion for “Human”. Also there would be different StudyProtocolVersion for different phases of Human trials like phase one to phase four and “trial_type_id” of link 118h, which has been added in accordance with an embodiment of the present invention, helps in categorization of the same. One or more embodiments of the present invention help in this categorization of data which would be very useful for data visualization by end users of our a computer software program implemented by computer processors 6 and/or 26 and stored in computer memories 2 and/or 22 in accordance with an embodiment of the present invention, for business intelligence reports.

The link or links 204 of FIG. 18, may include links 116j, 116k, and 116l shown in FIG. 15 for Bridg Adverse Event table 116. The links 116j, 116k, and 116l, have been added in accordance with an embodiment of the present invention to computer memory, such as 2 and/or 22, to connect the BRIDG Domain based AdverseEvent table 116 and commercial database tables of database 206, such as generic_product table 124, trials type table 126, and BRIDG Domain based animal table 106 of FIG. 10. The links 116j, 116k, and 116l assist in categorization of BRIDG domain based AdverseEvent data for different trial type. For example there would be a Adverse Event for an animal say a “Rat” and another Adverse Event for a “Human”. Also there would be different Adverse Events for different phases of human trials like phase one to phase four and “trial_type_id” link 116j helps in categorization of the same. One or more embodiments of the present Invention helps in this categorization of data which is very useful for data visualization by end users of a computer software program implemented by computer processors 6 and/or 26 and stored in computer memory 2 and/or 22, such as for business intelligence reports. The Adverse Event categorizations of table 116 in FIG. 15, is extremely useful to life sciences companies and plays a role in the success of any drug, medical device, or Therapy.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a computer memory;
a computer interactive device;
a computer processor linked by a communications link to the computer memory and to the computer interactive device;
wherein the computer processor is programmed by computer software stored in the computer memory to store in the computer memory a first plurality of database tables each of which include research data which relates to clinical or pre-clinical research studies concerning a biomedical product;
wherein the computer processor is programmed by computer software stored in the computer memory to store in the computer memory a second plurality of database tables each of which include non research data concerning the biomedical product but unrelated to clinical or pre-clinical research studies concerning the biomedical product; and
wherein the computer processor is programmed by computer software stored in the computer memory to link, in the computer memory, the second plurality of database tables with the first plurality of database tables.

2. The apparatus of claim 1 wherein
each of the first plurality of database tables is a biomedical research integrated domain group model database table.

3. The apparatus of claim 1 wherein
the non research data includes data about sales of the biomedical product.

4. The apparatus of claim 1 wherein
the non research data includes data about cost of the biomedical product.

5. The apparatus of claim 1 wherein
the non research data includes data about degradation of the biomedical product over a period of time.

6. The apparatus of claim 1 wherein
the non research data includes data about manufacturing of the biomedical product.

7. A method comprising
storing in computer memory a first plurality of database tables each of which include research data which relates to clinical or pre-clinical research studies concerning a biomedical product;
storing in the computer memory a second plurality of database tables each of which include non research data concerning the biomedical product but unrelated to clinical or pre-clinical research studies concerning the biomedical product; and
linking, in the computer memory, the second plurality of database tables with the first plurality of database tables.

8. The method of claim 7 wherein
each of the first plurality of database tables is a biomedical research integrated domain group model database table.

9. The method of claim 7 wherein
the non research data includes data about sales of the biomedical product.

10. The method of claim 7 wherein
the non research data includes data about cost of the biomedical product.

11. The method of claim 7 wherein
the non research data includes data about degradation of the biomedical product over a period of time.

12. The method of claim 7 wherein
the non research data includes data about manufacturing of the biomedical product.
